(19) United States
(12) Patent Application Publication
(10) Pub. No.: US 2005/0091334 A1
(43) Pub. Date: Apr. 28, 2005

(54) System and method for high performance message passing

(76) Inventors: Weiyi Chen, Hoover, AL (US); Rossen P. Dimitrov, Nashua, NH (US); Anthony Skjellum, Vestavia Hills, AL (US)

Correspondence Address: DUCKOR SPRADLING METZGER, 401 WEST A STREET, SUITE 2400, SAN DIEGO, CA, 92101-7915, US

(21) Appl. No.: 10/953,939

(22) Filed: Sep. 28, 2004

Related U.S. Application Data
(60) Provisional application No. 60/506,820, filed on Sep. 29, 2003.

(51) Int. Cl. G06F 15/167; G06F 15/16

(52) U.S. Cl. 709/216; 709/201

(57) ABSTRACT

A system and method are disclosed for high performance message passing between an origin computing node and a target computing node. A target progress thread is caused to receive a message from an origin process user thread to initiate a one sided communication operation. A target copy buffer of a target process thread is caused to respond to the received message for assisting in completing communication operations.

### RELATED APPLICATION

This application claims priority to U.S. provisional patent application, entitled SYSTEM AND METHOD FOR HIGH PERFORMANCE MESSAGE PASSING, Application No. 60/506,820, filed Sep. 29, 2003, the entirety of which is hereby incorporated herein by reference.

### FIELD OF THE INVENTION

The present invention in general relates to a system and method for high performance message-passing. It more particularly relates to such a system and method for parallel processing message passing between, for example, two computer nodes of a computer network.

### BACKGROUND OF THE INVENTION

There is no admission that the background art disclosed in this section legally constitutes prior art.

The constraints of high performance computing continue to be expanded with the ever increasing size and diversity of computational and data models that require processing. Some of the constraints in the message passing interface field of high performance computing have been the lack of one sided communication used in distributed shared memory environments. With the release of the MPI-2 standard, the message passing interface (MPI) field was presented with a standard that defined one sided communication operations. A one sided communication is defined as a communication routine that can be substantially completed by a single process such as an origin process, as used herein. The MPI-2 standard is described in “MPI-2: Extensions to the Message-Passing Interface,” Message Passing Interface Forum, Jul. 18, 1997 (http://www.mpi-forum.org/docs/mpi-20.ps), the entirety of which is hereby incorporated herein by reference. The MPI-2 standard does not define how one sided communications can be implemented. Instead, the MPI standard merely specifies an interface to them. An efficient and effective implementation for one sided communications would be highly desirable.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a block diagram of a computing system in accordance with an embodiment of the present invention;

FIG. 2 is a block diagram of one sided communication operations undertaken by the network of FIG. 1;

FIG. 3 is a more detailed block diagram of one sided communication protocols undertaken by the network of FIG. 1;

FIG. 4 is a flowchart diagram of short contiguous one sided communication protocols implemented on top of a communication with remote direct memory access (RDMA) support undertaken by the network of FIG. 1;

FIGS. 5 and 6 are a flowchart diagram of long contiguous one sided communication protocols implemented on top of a communication with RDMA support undertaken by the network of FIG. 1;

FIGS. 7 and 8 are a flowchart diagram of non-contiguous one sided communication protocols implemented on top of a communication with RDMA support undertaken by the network of FIG. 1;

FIG. 9 is a block diagram, similar to FIG. 3, of another set of one sided communication protocols undertaken by the network of FIG. 13;

FIG. 10 is a flowchart diagram of short contiguous one sided communication protocols implemented on top of transmission control protocol (TCP) socket interface undertaken by the network of FIG. 13;

FIG. 11 is a flowchart diagram of long contiguous one sided communication protocols undertaken by the network of FIG. 13;

FIG. 12 is a flowchart diagram of non-contiguous one sided communication protocols undertaken by the network of FIG. 13; and

FIG. 13 is a block diagram of another computing system in accordance with another embodiment of the invention.

### DETAILED DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiment of the invention.

A system and method are disclosed for high performance message passing between an origin computing node and a target computing node. A target progress thread is caused to receive a message from an origin process user thread to initiate a one sided communication operation. A target copy buffer of a target process thread is caused to respond to the received message for assisting in completing communication operations.

A system and method as disclosed relate to a system and method for high performance message passing utilizing one sided communication which may be compliant with the MPI-2 standard. The system and method may retain system scalability for applications while balancing performance criteria and resource utilization. The implementation of this feature may provide a reduction in the communications overhead between the computing nodes in an MPI application under some circumstances.

In one embodiment of this invention, the system and method for high performance message passing utilizes one sided communication techniques performed between an origin process such as one operating on an origin process computer node, and a target process such as one operating on a target process computer node whose memory may be accessed substantially transparently in respect to the user code being executed by the target process. The one sided operations implemented by the disclosed embodiments of this invention may include PUT, GET, and ACCUMULATE.

In the disclosed embodiment of the present invention, the system and method for high performance message passing may be executed on a plurality of computing nodes. In the embodiment of the present invention, the computing nodes may be one or more of a variety of computer processors such, for example, as IBM compatible personal computers, mini-computers, mainframes, supercomputers, other hardware configurations known to those skilled in the art, or combinations thereof, as well as others.

In another embodiment of the present invention, the computing nodes may utilize a suitable operating system such as a Linux operating system. Alternatively, other operating systems such as FreeBSD, Solaris, Windows, or other operating systems may be used.

In yet another embodiment of the present invention, the system and method for high performance message passing communicates may employ Gigabit Ethernet, Myrinet, InfiniBand, or combinations thereof and others. Other communication networks will become readily apparent to those skilled in the art.

According to other embodiments of the present invention, the system and method for one sided communication may perform communication between various networks such, for example, as MPI processes using Transmission Control Protocol/Internet Protocol (TCP/IP), Myrinet GM, Mellanox VAPI (Infiniband), inter-process communication on symmetric multiprocessor platforms (SMP), or combinations thereof, as well as others. Other communication protocols, interfaces, and methods will become apparent to those skilled in the art.

The system and method for one sided communication according to certain embodiments of the invention may utilize contiguous and non-contiguous target data type communication. Additionally, other embodiments of the present invention may utilize active and passive synchronization (lock/unlock).

Other embodiments of the present invention may employ one or more user threads that execute the user code of the application.

The system and method of the disclosed embodiments for one sided communications may utilize an independent progress thread in order to process incoming communication requests. The progress thread may run in parallel with the user thread that executes the user code of, for example, an MPI application. The operation of the progress thread may not require any intervention of the user thread. Thus, in one sided communication operations, including non-contiguous communications, accumulate operations and passive synchronizations, the user thread of the target process may not explicitly be involved in the one sided communication operations. This may make one sided operations transparent to the target user thread. Applications may aggregate communications in an access epoch, and perform computation simultaneously while one sided communications may be performed. This arrangement may ensure the timely progress of the communication, as well as amortizing of synchronization overhead. It may also allow for overlapping of communication and computation to maximize or at least improve application performance.

In yet another embodiment of the present invention, the one sided operations may be implemented on top of high performance primitives provided by low level communication interfaces, such as GM and VAPI, in order to achieve maximum or at least a high level communication performance. These communication primitives may include operating system bypass send and receive operations as well as remote direct memory access (RDMA) operations. RDMA is a set of technologies that enable the movement of data from the memory of one device directly, or at least substantially directly, into the memory of another device without involving the operating system of either device. The RDMA operations may be implemented through hardware engines on the network interfaces that perform data movement from the memory space of the origin process to the memory space of the target process without the involvement of the host processors of both communicating compute nodes. The RDMA operations can be Read and Write. For instance, RDMA Write operations are provided by both Mellanox VAPI and Myrinet GM, while RDMA Read operations are supported by Mellanox VAPI but not by Myrinet GM.

For utilizing RDMA, the communicating processes may require both the origin and target buffers to be locked in physical memory. Since the target buffer may be within the boundaries of the target memory window, the target buffer is locked during initialization of a MPI_Win object for the particular one sided communication context. The window is a designated segment of the computer memory used for the communication. The origin buffer can be in any location in the virtual space of the origin buffer, within or outside of the origin memory window. In the latter case the origin buffer will need to be locked prior to every one sided communication operation. Locking user buffers in physical memory is generally a high-overhead operation and its use is justified only when the exchanged buffers are large. Since locking in physical memory is performed in units of pages, (a page is usually 4 or 8 kilobytes long), the overhead caused by memory locking for small buffers (e.g., less than 1 kilobyte) may dominate the transmission time and thus make the entire one sided operation less efficient. Another disadvantage for some applications is that memory locking requires invocation of the operating system kernel, which may be a high overhead operation.

According to other embodiments of the present invention, protocols may be implemented for contiguous and non-contiguous target data type operations depending on whether or not the target buffer occupies contiguous memory in the target process space. The contiguous protocol in turn may have two modes based on the size of the communicated buffers: short and long. A tunable parameter may be used to specify the cutoff message size between the short and long modes of the contiguous protocol.

The long contiguous protocol may perform one sided communication operations using RDMA primitives on networks with RDMA support. The disclosed embodiments of the present invention may exploit, for example, both the RDMA Write and RDMA Read capabilities of a Mellanox VAPI interface or other. RDMA operations are used whenever possible and efficient. All operations that cannot be performed through RDMA may be handled by the progress threads. The long contiguous protocol may not involve the target progress thread and may avoid intermediate data copies. This may have the advantage in certain applications of yielding a higher effective communication bandwidth.

On networks and low level interfaces that lack RDMA support, such as the BSD sockets interface to the TCP/IP communication stack, long contiguous protocol may be implemented by sending request packets to the progress thread of the target process and utilizing an additional thread, called Long Send Thread (LST), in both origin and target processes. The LST may emulate RDMA in software. The non-contiguous protocol may carry a lightweight target type map description supplied by the origin process. The progress thread of the target process may use this type map to reconstruct the required target data type on the fly and perform appropriate data unpacking operations in the target window.

Synchronization operations may be implemented according to certain embodiments of the invention through the use of progress threads of each process participating in one sided operations.

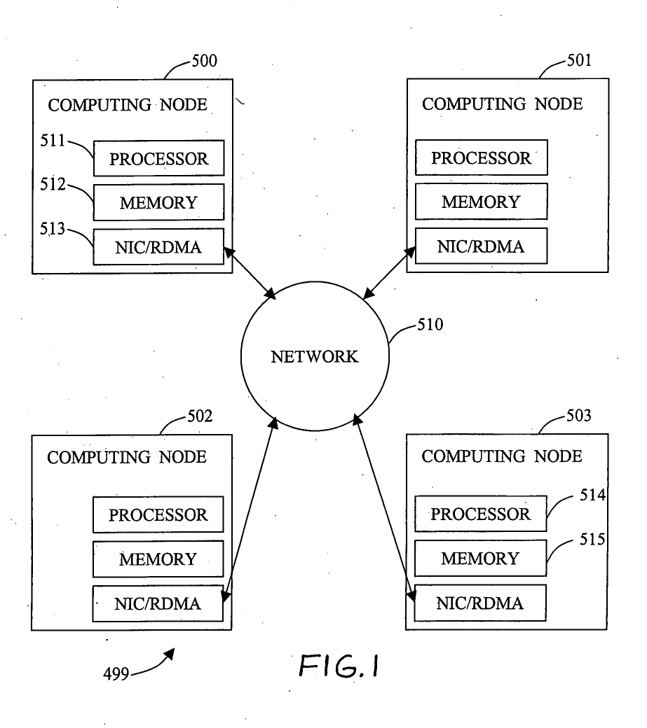

Referring now to the drawings and more particularly to FIG. 1, there is shown a computing system 499, which is constructed in accordance with an embodiment of the present invention. The computing system 499 includes a group of computing nodes such as computing nodes 500, 501, 502 and 503, which are connected to a network 510 through which the computing nodes communicate.

Each node is similar to one another, and only the node 500 will now be described. The node 500 includes a processor 511, which utilizes a memory 512. An RDMA equipped network interface controller communication unit 513 of the node 500 is used for high speed communication via the network 510 with other nodes.

In operation, each computing node may execute an MPI process, which may be a part of an MPI application. The MPI process may use one sided operations to communicate with the other MPI processes being executed by another node, via the network 510. Various configurations of the computing nodes, network, and MPI processes will become apparent to those skilled in the art.

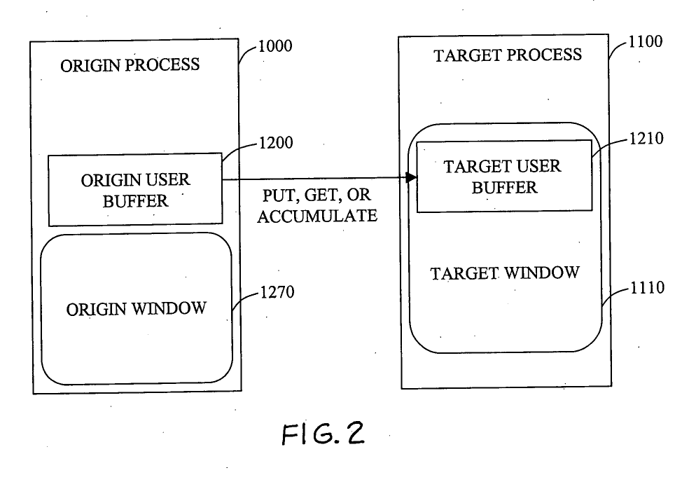

Referring now to FIG. 2, in operation, two processes such as two MPI processes may engage in a one sided communication in accordance with an embodiment of the present invention. For example, an origin process 1000 executed by the processor 511, and a target process 1100 of a processor 514 of node 503, are provided. The origin process 1000 initiates a one sided communication operation from its origin user buffer 1200 within the memory 512, to a target user buffer 1210 (within a memory 515 of node 503) of the target process 1100. The target buffer 1210 is within the boundaries of a target memory window 1110 designated within memory 515. The origin buffer 1200 can be either within an origin window 1270 designated within the memory 512, or outside the window 1210. FIG. 2 shows the origin buffer 1200 outside the window 1270. Both the origin and target buffers can be either contiguous or non-contiguous. The origin and target processes may be located on the same computing node or on separate computing nodes. All processes participating in one sided communication operations expose their memory windows during the creation of a MPI_Win object that is used for defining the scope of the communication context. A PUT, GET, ACCUMULATE or other message passing may be executed.

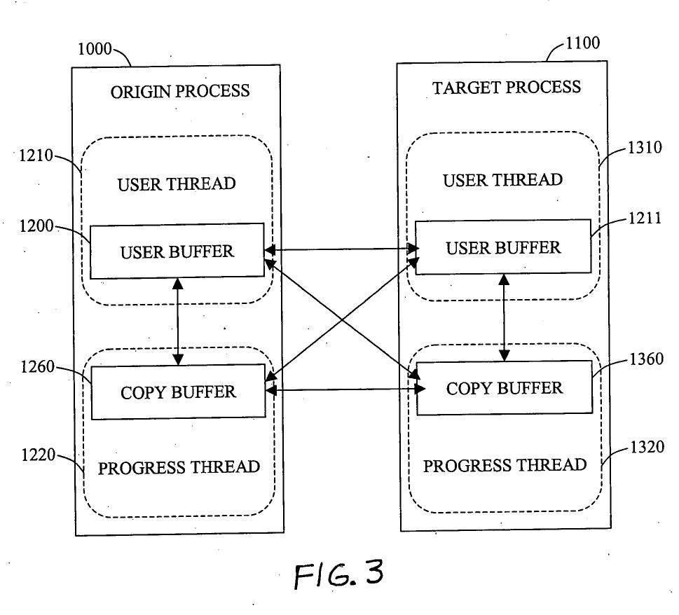

With reference to FIGS. 1 and 3, the one sided communication protocols are implemented on top of communication interfaces with RDMA support according to an embodiment of the present invention as shown. Such communication interfaces with RDMA support may include Myrinet GM and Mellanox VAPI. The origin process 1000 performs a one sided communication operation (PUT, GET, or ACCUMULATE) to a target process 1110.

A PUT operation transfers data from the origin process 1000 to the target process 1100. A GET operation transfers data from the target process 1100 to the origin process 1000. An ACCUMULATE operation updates locations in the target process 1100 (e.g. by adding to those locations values sent from the origin process).

The one sided communication protocols implementing these operations involve an origin user thread 1210, an origin progress thread 1220 executed by the processor 511, and the target progress thread 1320. The target user thread 1310 may not be directly involved in the execution of the protocols. An origin user buffer 1200 and a target user buffer 1211 are utilized by the respective origin user thread 1210 and the target user threat 1310. Also, copy buffers 1260 and 1360 are used by the progress threads 1220 and 1320 respectively for the origin and target processes. These copy buffers are used internally by the one sided protocols. When the origin user thread 1210 of the origin process 1000 attempts to perform a short contiguous one sided message passing operation to the target process 1100 being executed by the processor 514, the origin user thread 1210 sends a request to the target progress thread 1320 of the target process 1100. If the one sided operation is a PUT operation or an ACCUMULATE operation, the request also contains the origin user data contained in the origin buffer 1200. When the target progress thread 1320 receives the request in the target copy buffer 1360, it then either performs the requested accumulation operation onto the target user buffer 1211 for an ACCUMULATE operation, or directly deposits the data into the target buffer 1360 for a PUT operation. If the requested short contiguous operation is a GET operation, the target progress thread 1320 obtains data from the target user buffer 1211 and sends it to the origin progress thread 1220, which in turn deposits the target data into the origin user buffer 1200.

For long contiguous PUT operations, the origin user thread 1210 initiates an RDMA Write transfer, which deposits the data from the origin user buffer 1200 directly into the target buffer 1211, thereby avoiding the target copy buffer 1360. If the origin user buffer 1200 is outside the boundaries of the origin memory window 1270 (FIG. 2), a physical memory locking operation may be necessary in order to facilitate the RDMA transfer. If the origin user buffer is within the boundaries of the origin window, such locking may not be necessary. For long contiguous ACCUMULATE operations, the origin user thread 1210 sends a request to the target progress thread 1320. On networks with RDMA Read support, the target progress thread may initiate an RDMA Read operation from the origin user buffer 1200 to the target copy buffer 1360. On networks without RDMA Read support, the target progress thread 1320 may send a reply message to the origin progress thread 1220, which initiates an RDMA Write transfer from the origin user buffer 1200 into the target copy buffer 1360. When the transfer completes, the target progress thread 1320 performs the accumulation operation of the copy buffer 1360 onto the target user buffer 1211.

For long contiguous GET operations, depending on the support for RDMA Read operations, two options may be implemented. On networks with RDMA Read support, such as InfinIband with Mellanox VAPI interface, the origin user thread 1210 initiates an RDMA Read transfer from the target user buffer 1211 to the origin user buffer 1200. For networks without RDMA Read, such as Myrinet GM, the origin user thread 1210 sends a request to the target progress thread, which in turn initiates an RDMA Write operation between the target user buffer 1211 and the origin user buffer 1200.

In the non-contiguous protocol for PUT operations, the origin user thread 1210 sends a request describing the size of the origin user buffer 1200 to the target progress thread 1320, which allocates the target copy buffer 1360 with this size. If the underlying communication interface supports RDMA Read (e.g., Mellanox VAPI), the target progress thread 1320 initiates an RDMA Read from the origin user buffer 1200 into the target copy buffer 1360. If the underlying communication interface does not support RDMA Read (e.g., Myrinet GM), the target progress thread 1320 sends a reply to the origin progress thread 1220, which in turn initiates an RDMA Write to the target copy buffer 1360. The non-contiguous PUT operation ends with the target progress thread 1320 unpacking the data from the target copy buffer 1360 into the target user buffer 1211. If the non-contiguous operation is a GET operation, the origin user thread 1210 sends a request to the target progress thread 1320, which packs the target user buffer 1210 into the target copy buffer 1360 and initiates an RDMA Write into the origin user buffer 1200.

For all three protocols, if the origin user buffer 1200 is also non-contiguous, for PUT and ACCUMULATE operations, it is first packed in the origin copy buffer 1260 and all communication involving the origin user buffer is redirected to the origin copy buffer. For GET operations, the incoming target data is first stored in the origin copy buffer 1260 before being unpacked into the origin user buffer 1200.

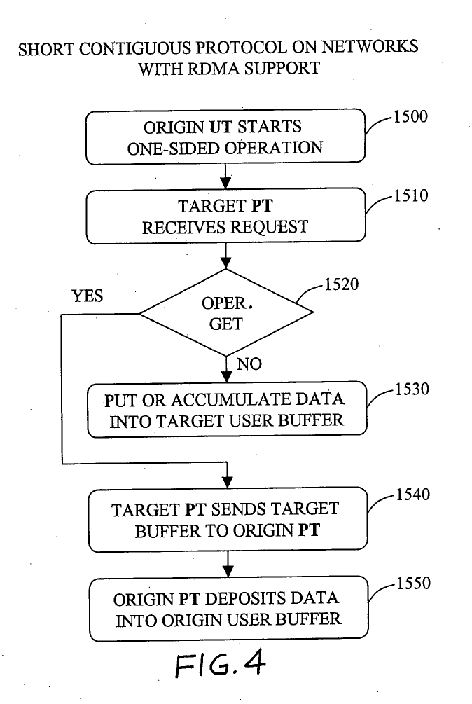

Referring now to FIG. 4, a method for one sided communication according to an embodiment of the present invention will now be described for the short contiguous protocol on networks with RDMA support as shown in FIGS. 1, 2 and 3. User threads are denoted in the diagram with the acronym UT while the progress threads are denoted with the acronym PT.

The protocol begins in box 1500 where the origin user thread starts a one sided operation as described heretofore. The target progress thread then receives a request as shown in box 1510. A determination is made by the progress thread if the operation is a GET operation as shown in decision box 1520. If the operation is not a GET operation, data is then either PUT or ACCUMULATED into the target buffer as shown in box 1530 where the protocol then terminates. If the operation is a GET operation, then the target progress thread 1320 sends its target buffer 1360 to the origin progress thread 1220 as shown in box 1540. Next, the origin progress thread deposits data into the origin user buffer 1200 as shown in box 1550 where the protocol then terminates.

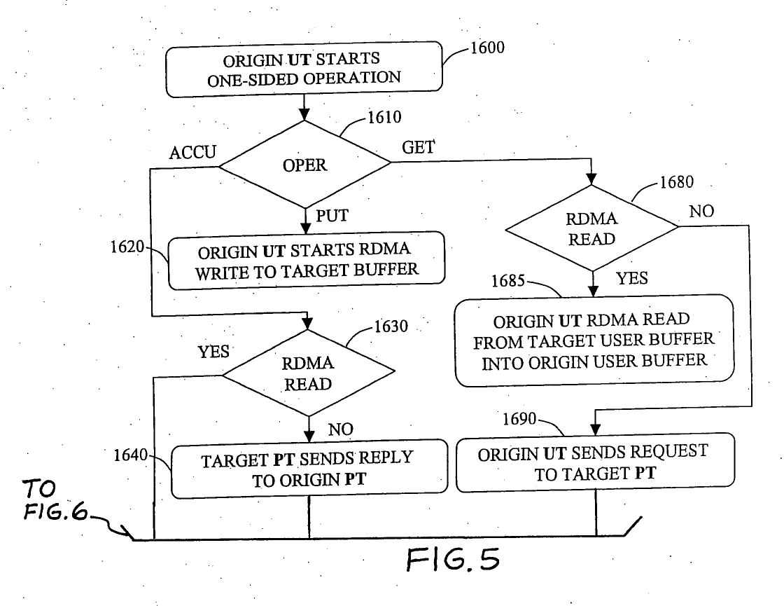

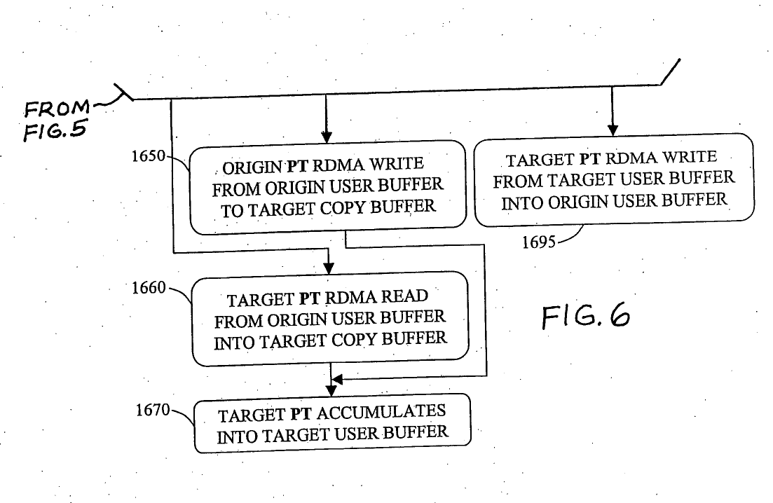

Referring now to FIGS. 5 and 6, the long contiguous protocol on networks with RDMA support according to an embodiment of the present invention will now be described. The protocol begins by the origin user thread starting a one sided operation as shown in box 1600. As shown in decision box 1610, a decision is performed to determine the type of operation being performed, which could either be a PUT, a GET, or an ACCUMULATE. If the operation is a PUT, the origin user thread starts an RDMA right to the target buffer as shown in box 1620. If the operation is a GET, as indicated in box 1680, a determination is then made whether or not RDMA READ capability is present as heretofore described. If RDMA READ capability is present, the origin user thread RDMA READ is performed from the target user buffer 1211 into the origin user buffer 1200 as shown in box 1685. If RDMA READ capability is not present, then the origin user thread 1210 sends a request to the target progress thread 1320 as shown in box 1690. The target progress thread 1320 then performs an RDMA WRITE from the target user buffer 1211 into the origin user buffer 1200 as shown in box 1695.

If the operation as determined in box 1610 is an ACCUMULATE, a subsequent determination is then made whether or not RDMA READ is available as shown in decision box 1630. If RDMA READ capability is available, the target progress thread 1320 initiates an RDMA READ from the origin user buffer 1200 into the target copy buffer 1360 as shown in box 1660. The target progress thread 1320 then ACCUMULATES into the target user buffer 1211 as shown in box 1670. If RDMA READ is not available as determined in decision box 1630, then the target progress thread 1320 sends a reply to the origin progress thread 1220 as shown in box 1640. The origin progress thread then initiates an RDMA WRITE from the origin user buffer 1200 to the target copy buffer 1360 as shown in box 1650. The target progress thread 1320 then ACCUMULATES into the target user buffer 1211 as shown in box 1670.

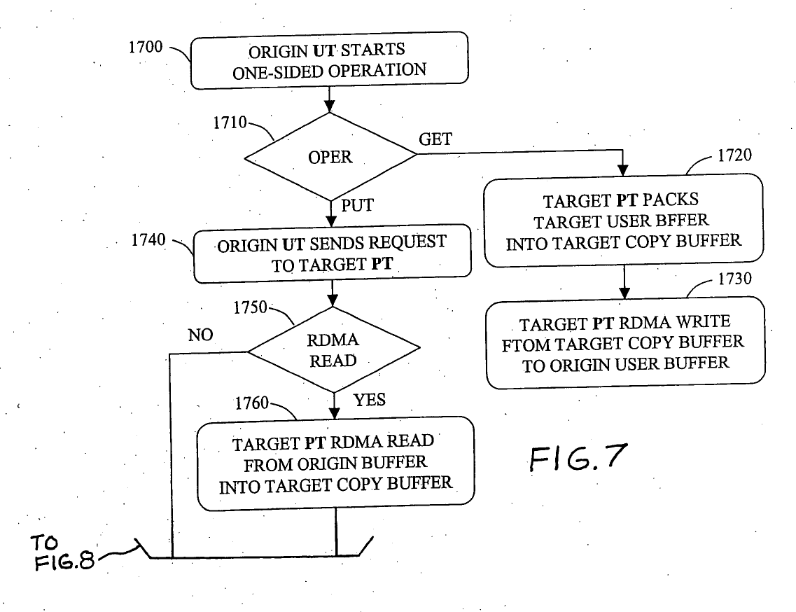

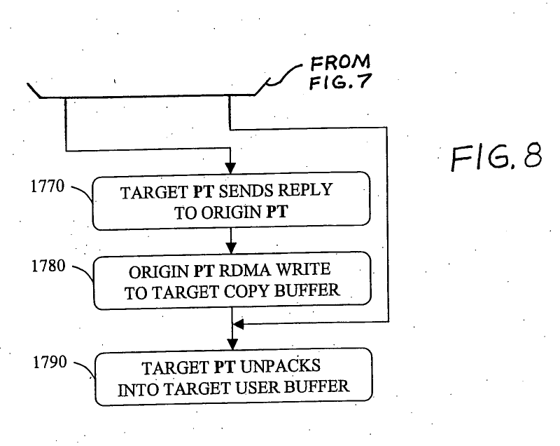

Referring now to FIGS. 7 and 8 there is shown a method for one sided communication, according to an embodiment of the present invention, for non-contiguous protocol on networks with RDMA support as shown in FIG. 3.

The protocol begins by the origin user thread 1210 starting a one sided operation as shown in box 1700. A determination is then made whether the operation is a GET or a PUT as shown in decision box 1710. If the operation is a GET, the target progress thread 1320 packs the target user buffer 1211 into the target copy buffer 1360 as shown in box 1720. The target progress thread 1320 then initiates an RDMA WRITE from the target copy buffer 1360 to the origin user buffer 1260 as shown in box 1730.

If the operation is a PUT, as shown in decision box 1710, then the origin user thread 1210 sends a request to the target progress thread 1320 as shown in box 1740. As shown in decision box 1750, a determination is then made whether or not RDMA READ capability is present. If RDMA READ capability is present, the target progress thread 1320 initiates an RDMA READ from the origin buffer into the target copy buffer 1360 as shown in box 1760. The target progress thread 1320 then unpacks into the target user buffer 1211 as shown in box 1790.

If RDMA READ capability is not present, as shown in decision box 1750, then the target progress thread 1320 sends a reply to the origin progress thread 1220 as shown in box 1770. The origin progress thread 1220 then initiates an RDMA WRITE to the target copy buffer 1360 as shown in box 1780. The target progress thread 1320 then unpacks into the target user buffer 1211 as shown in box 1790.

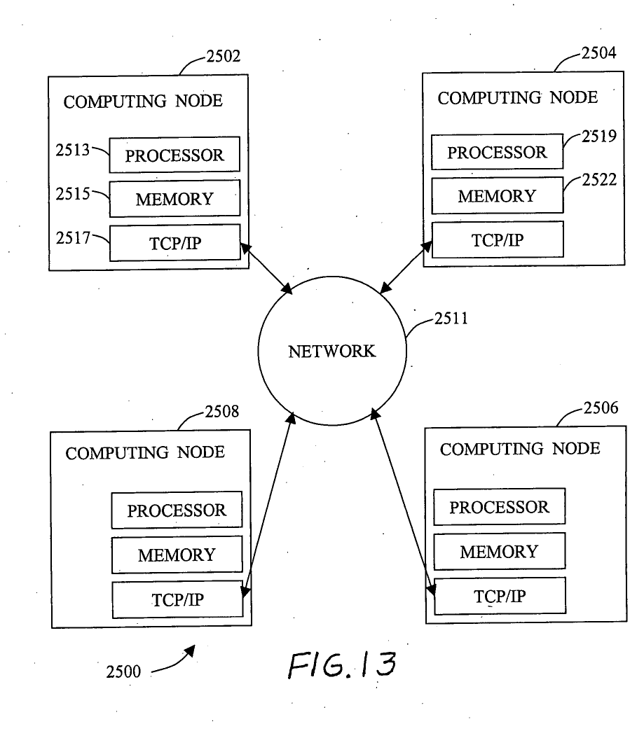

Referring now to FIG. 13, there is shown a computing system 2500, which is similar to the system 499 of FIG. 1, except the system 2500 is equipped to support TCP/IP communications. The system 2500 includes a group of computing nodes such as nodes 2502, 2504, 2506 and 2508 which communicate with one another via a network 2511 such as the Internet.

The nodes are similar to one another and only the node 2502 will now be described in greater detail. The node 2502 includes a processor 2513 and a memory 2515. The node 2502 is equipped with a TCP/IP communication unit 2517 for communicating with the other similarly equipped nodes such as the nodes 2504, 2506 and 2508.

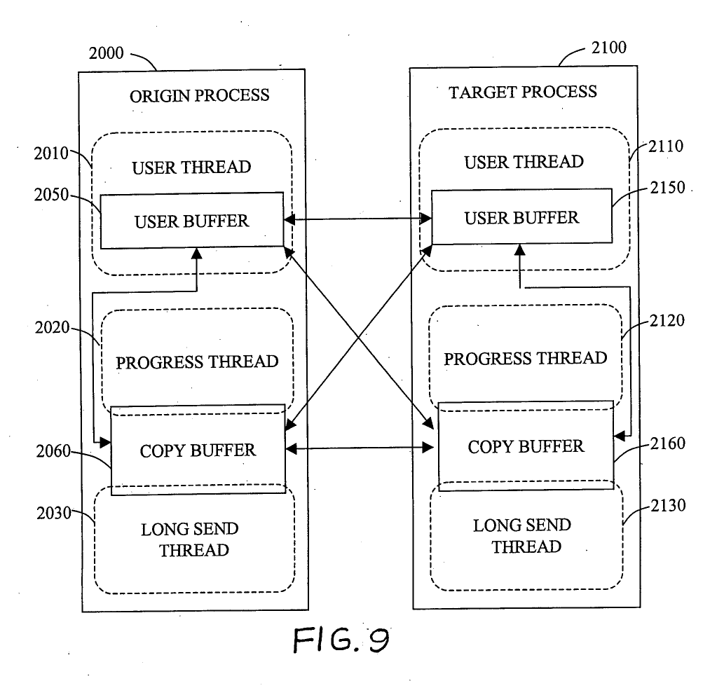

Referring to FIG. 9, there is shown a method of one sided protocols implemented on top of BSD sockets interface of the TCP/IP communication stack according to an embodiment of the present invention such as the system of FIG. 13. The sockets interface is selected as an instance of interface that does not support RDMA operations. Other similar communication interfaces lacking RDMA support will be readily apparent to those skilled in the art.

The one sided communication protocols implementing these operations involve an origin user thread 2010, an origin progress thread 2020, an origin long send thread 2030, a target progress thread 2120, and a target long send thread 2130. The target user thread may not be involved in the implementation of the protocols. Assume the origin threads may be executed by the processor 2513 of the node 2502, and the target threads may be executed by a processor 2519 of the node 2504. The origin buffers are a part of the memory 2515, and the target buffers may be a part of a memory 2522 of the node 2504.

Three protocols are implemented depending on the size of the transmitted data and whether the target buffer is contiguous or non-contiguous, namely: short contiguous, long contiguous, and non-contiguous. As shown in FIG. 9, an origin user buffer 2050 and a target user buffer 2150 are included in the nodes 2502 and 3504, respectively. Also, copy buffers 2060 and 2160 used by the progress and long send threads of the origin and target processes are also included in the respective nodes 2502 and 2504. These copy buffers are used internally by the one sided protocols. The origin process 2000 is communicating with the target process 2100. The processes may alternatively be executed by the same computing node or on separate computing nodes.

When the origin user thread 2010 attempts to perform a short contiguous operation, it first sends a request to the target progress thread 2020. If the requested operation is a PUT or an ACCUMULATE, the request is accompanied with the user data. The target progress thread 2120 receives the request and if the requested operation is a PUT, it deposits user data directly into the user buffer 2150 of the target process 2100. If the operation is an ACCUMULATE, the target progress thread 2120 allocates a target copy buffer 2160, stores the incoming data into the copy buffer and then performs the accumulate operation onto the target user buffer 2150. If the short contiguous operation is a GET, the target progress thread 2120 signals the target long send thread 2130, which in turn sends the target user buffer 2150 to the origin progress thread 2020. The origin progress thread 2020 receives the data and then deposits it into the origin user buffer 2050.

If the requested one sided operation is a long contiguous one, and the operation is a PUT or an ACCUMULATE, the origin long send thread 2030 sends the data in the origin user buffer 2050 to the target progress thread 2120. If the operation is a PUT, the target progress thread 2120 deposits the data directly into the target user buffer 2150. If the operation is an ACCUMULATE, the progress thread 2120 stores the data in the target copy buffer 2160 and then performs the accumulate operation into the target user buffer 2150. If the requested one sided operation is long contiguous and the operation is a GET, the origin user thread 2010 sends a request to the target progress thread 2120, which signals the target long send thread 2130. The target long send thread 2130 then sends the data in the target buffer 2150 to the origin progress thread 2020, which deposits the data into the origin user buffer 2050.

For non-contiguous PUT operations, if the origin user buffer is shorter than a pre-defined threshold, the data in the origin user buffer 2050 is sent to the target progress thread 2120 by the origin user thread 2010. If the origin user buffer 2050 is longer than the threshold, this buffer data is sent to the target progress thread 2120 by the origin long send thread 2030. Once the target progress thread 2120 receives the data from the origin process, the target progress thread stores the data into the target copy buffer 2160 and then unpacks this buffer into the target user buffer 2150. For the non-contiguous GET operations, the origin user thread 2010 sends a request to the target progress thread 2120, which packs the target buffer 2150 into a copy buffer 2160 and signals the target long send thread 2130. The target long send thread 2130 sends the target copy buffer to the origin progress thread 2020, which in turn deposits the data into the origin user buffer 2050.

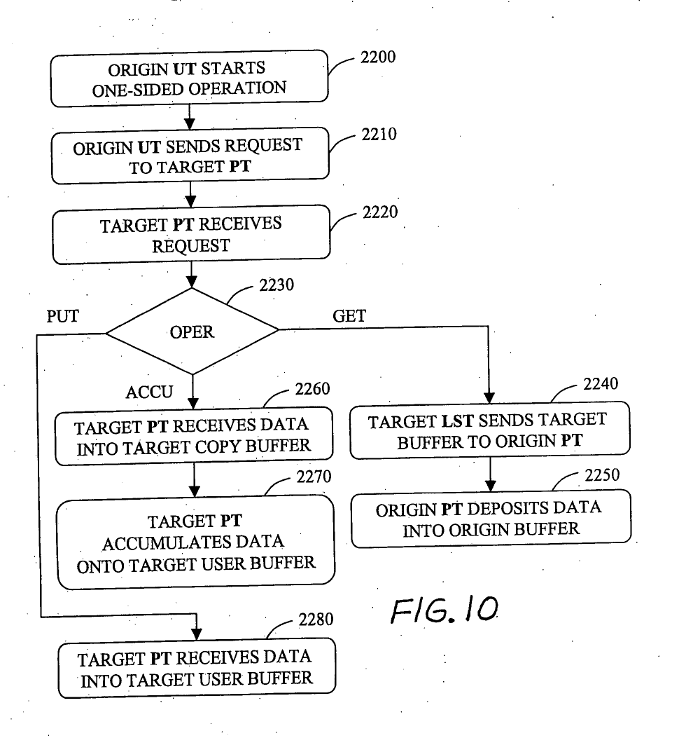

Referring to FIG. 10, there is shown a short contiguous protocol on systems such as the system 2500 of FIG. 13 without RDMA support. For shortness of expression, user threads are denoted in the diagram of FIG. 8 with the acronym UT, progress threads are denoted with the acronym PT, and the long send threads with the acronym LST.

The protocol begins by the origin user thread starting a one sided operation as shown in box 2200. The origin user thread then sends a request to the target progress thread as shown in box 2210. The target progress thread then receives the request as shown in box 2220.

A decision is then made as shown in decision box 2230 to determine what operation is being performed. If the operation is a GET, then the target long send thread sends the target buffer data to the origin progress thread as shown in box 2240. The origin progress thread then deposits data into the origin buffer as shown in box 2250.

If the operation as detected in decision box 2230 is an ACCUMULATE, then the target progress thread receives the data into the target copy buffer as shown in box 2260. The target progress thread then ACCUMULATES data into the target user buffer as shown in box 2270.

If the operation as determined by decision box 2230 is a PUT, then the target progress thread receives the data into the target user buffer as shown in box 2280.

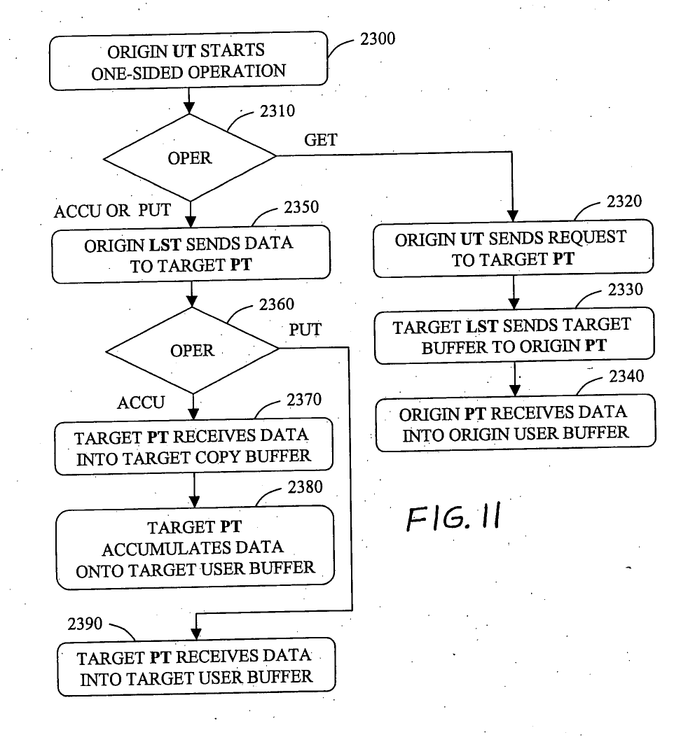

Referring now to FIG. 11, there is shown a method of a long contiguous protocol on systems such as the system 2500 without RDMA support presented is shown. The protocol begins by the origin user thread starting a one sided operation as shown in box 2300.

A decision is made whether the operation is either a GET or an ACCUMULATE or a PUT as shown in box 2310. If the operation is a GET, then the origin user thread sends a request to the target progress thread as shown in box 2320. The target long send thread sends the target buffer data to the origin progress thread as shown in box 2330. The origin progress thread then receives data into the origin user buffer as shown in box 2340.

If the operation is instead an ACCUMULATE or a PUT as determined in decision box 2310, then the origin long send thread sends data to the target progress thread as shown in box 2350. A determination is then made whether or not the operation is either a PUT or an ACCUMULATE as shown in decision box 2360. If the operation is a PUT, then the target progress thread receives the data into the target user buffer as shown in box 2390. If instead the operation is an ACCUMULATE as shown in box 2360, then the target progress thread receives data into the target copy buffer as shown in box 2370. The target progress thread then accumulates data onto the target user buffer, as shown in box 2380.

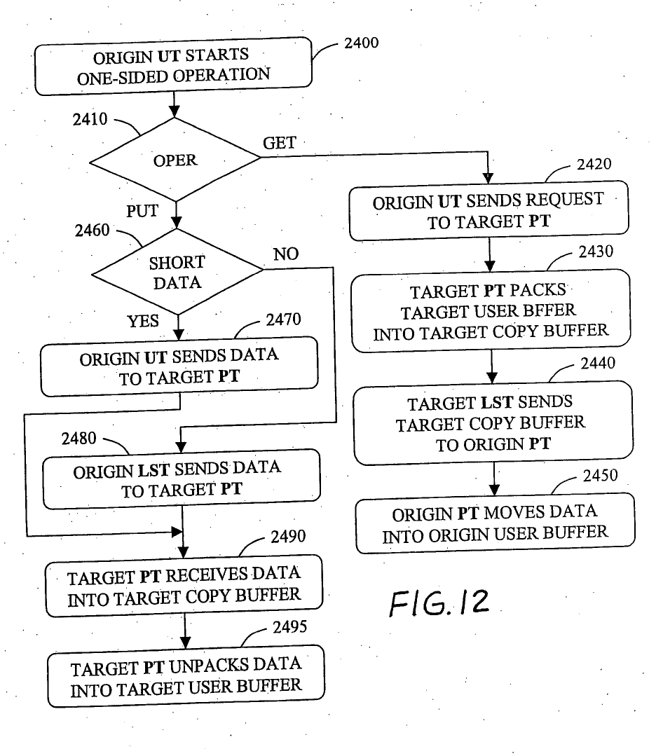

Referring now to FIG. 12, there is shown a non-contiguous protocol on a system such as the system 2500 without RDMA support. The protocol begins by the origin user thread starting a one sided operation as shown in box 2400.

A determination is then made whether or not the operation is a GET or a PUT as shown in decision box 2410. If the operation is a GET, then the origin user thread sends a request to the target progress thread as shown in box 2420. The target progress thread then packs the target user buffer into the target copy buffer as shown in box 2430. The target long send thread then sends the target copy buffer to the origin progress thread as shown in box 2440. Then the origin progress thread moves the data into the origin user buffer as shown in box 2450.

On the other hand, if the operation was a PUT as determined in decision box 2410, then another decision is made in decision box 2460 determining whether or not the data is short. If the data is short, the origin user thread sends data to the target progress thread as shown in box 2470. The target progress thread then receives the data into the target copy buffer as shown in box 2490. The target progress thread then unpacks the data into the target user buffer as shown in box 2495.

Instead, if the data is not short as determined at decision box 2460, the origin long send thread sends data to the target progress thread as shown in box 2480. The target progress thread then receives the data into the target copy buffer as shown in box 2490 and the target progress thread then unpacks the data into the target user buffer as shown in box 2495.

While particular embodiments of the present invention have been disclosed, it is to be understood that various different modifications are possible and are contemplated within the true spirit and scope of the appended claims. For example, the short contiguous protocol on systems without RDMA support as shown in FIGS. 10 and 11, could be performed on other networks that use another protocol besides TCP/IP. There is no intention, therefore, of limitations to the exact abstract or disclosure herein presented.

1. A method for high performance message passing between an origin computing node and a target computing node, comprising:
using an origin process user thread and an origin user buffer of the origin computing node;
using a target process user thread with a target user buffer, and using a target progress thread with a target copy buffer of the target computing node;
causing the target progress thread to receive a message from the origin process user thread to initiate a one sided communication operation; and
causing the target copy buffer to respond to the received message for assisting in completing communication operations.

2. A method according to claim 1, further including using an origin process user thread and an origin copy buffer of the origin computing node.

3. A method according to claim 2, further including depositing the origin user data into the target copy buffer after the target progress thread receives the message from the origin process user thread.

4. A method according to claim 2, further including causing an accumulation operation to occur via the target progress thread onto a target user buffer of the target computing node.

5. A method according to claim 2, further including:
causing the target progress thread to receive data into the target copy buffer; and
causing the target progress thread to accumulate the origin user data onto a target user buffer of the target computing node.

6. A method according to claim 1, further including:
providing target data in the target copy buffer; and
causing the target data to be deposited into the origin user buffer via the target progress thread.

7. A method according to claim 1, further including:
providing target data in the target copy buffer; and
causing the target data to be deposited into the origin user buffer via the long send thread.

8. A method according to claim 1, further including communicating the messages via RDMA.

9. A method according to claim 1, further including:
providing origin user data of the origin computing node; and
initiating an RDMA write transfer from the origin user thread to the target user buffer.

10. A method according to claim 1, further including:
providing origin user data of the origin computing node; and
causing the origin long send thread to send the origin user data to the target progress thread.

11. A method according to claim 10, further including causing the target progress thread to receive the origin user data into the target user buffer.

12. A method according to claim 10, further including:
causing the target progress thread to receive the origin user data into the target copy buffer; and
causing the target progress thread to accumulate the origin user data onto the target user buffer.

13. A method according to claim 9, wherein the origin process further including using an origin computing node memory window having boundaries and performing a physical memory locking operation if the origin user buffer is outside the boundaries of the origin computing node memory window.

14. A method according to claim 1, further including providing origin user data of the origin computing node;
initiating an RDMA read operation from the origin user buffer to the target copy buffer;
performing an accumulation operation of the target copy buffer onto the target user buffer.

15. A method according to claim 1, further including providing origin user data of the origin computing node;
sending a reply message from the target progress thread to the origin progress thread;
initiating an RDMA write transfer from the origin user buffer to the target copy buffer;
performing an accumulation operation of the target copy buffer onto a target user buffer of the target computing node.

16. A method according to claim 1, further including initiating an RDMA read transfer from a target user buffer of the target computing node.

17. A method according to claim 1, further including
sending a request to the target process thread for initiating an RDMA write operation; and
initiating an RDMA write operation between a target user buffer of the target computing node and the origin user buffer.

18. A method according to claim 1, further including
initiating an RDMA read from the origin user buffer to the target copy buffer; and
unpacking the data from the target copy buffer into a target user buffer of the target computing node.

19. A method according to claim 18, wherein the message further includes the size of the origin user buffer.

20. A method according to claim 1, further including sending a reply from the target progress thread to an origin progress thread;
initiating a write operation from the origin user buffer to the target copy buffer;
unpacking the data from the target copy buffer into a target user buffer of the target computing node.

21. A method according to claim 20, wherein the message further includes the size of the origin user buffer.

22. A method according to claim 1, further including
packing a target user buffer of the target computing node into the target copy buffer; and
initiating an RDMA write from the target copy buffer into the origin user buffer.

23. A method according to claim 1, further including
providing origin user data of the origin computing node;
causing a long send thread to send the origin user data to the target process thread;
causing the target progress thread to receive the origin user data into the target copy buffer; and
unpacking the received origin user data into a target user buffer of the target computing node.

24. A method according to claim 1, further including
providing origin user data of the origin computing node;
causing the long send thread to send data in the origin user buffer to the target progress thread;
causing the target progress thread to receive the origin user data into the target copy buffer; and
unpacking the received origin user data into a target user buffer of the target computing node.

25. A system for high performance message passing between an origin computing node and a target computing node, comprising:
means for using an origin process user thread and an origin user buffer of the origin computing node;
means for using a target process user thread with a target user buffer, and using a target progress thread with a target copy buffer of the target computing node;
means for causing the target progress thread to receive a message from the origin process user thread to initiate a one sided communication operation; and
means for causing the target copy buffer to respond to the received message for assisting completing of communication operation.

26. An apparatus according to claim 25, further including means for providing origin user data of the origin computing node, wherein the message includes the origin user data.

27. An apparatus according to claim 25, further including:
means for providing target data in the target copy buffer; and
means for causing the target data to be deposited into the origin user buffer via the target progress thread.

28. An apparatus according to claim 25, further including:
means for providing target data in the target copy buffer; and
means for causing the target data to be deposited into the origin user buffer via the long send thread.

29. An apparatus according to claim 25, further including means for communicating the messages via RDMA.

30. An apparatus according to claim 25, further including:
means for providing origin user data of the origin computing node; and
means for initiating an RDMA write transfer from the origin user thread to the target user buffer.

31. An apparatus according to claim 25, further including:
means for providing origin user data of the origin computing node; and
means for causing the origin long send thread to send the origin user data to the target progress thread.

32. An apparatus according to claim 25, further including
means for providing origin user data of the origin computing node;
means for initiating an RDMA read operation from the origin user buffer to the target copy buffer;
means for performing an accumulation operation of the target copy buffer onto the target user buffer.

33. An apparatus according to claim 25, further including
means for providing origin user data of the origin computing node;
means for sending a reply message from the target progress thread to the origin progress thread;
means for initiating an RDMA write transfer from the origin user buffer to the target copy buffer;
means for performing an accumulation operation of the target copy buffer onto a target user buffer of the target computing node.

34. An apparatus according to claim 25, further including means for initiating an RDMA read transfer from a target user buffer of the target computing node.

35. An apparatus according to claim 25, further including
means for sending a request to the target process thread for initiating an RDMA write operation; and
means for initiating an RDMA write operation between a target user buffer of the target computing node and the origin user buffer.

36. An apparatus according to claim 25, further including
means for initiating an RDMA read from the origin user buffer to the target copy buffer; and
means for unpacking the data from the target copy buffer into a target user buffer of the target computing node.

37. An apparatus according to claim 25, further including
means for sending a reply from the target progress thread to the origin progress thread;
means for initiating an RDMA write from the origin user buffer to the target copy buffer;
means for unpacking the data from the target copy buffer into a target user buffer of the target computing node.

38. An apparatus according to claim 25, further including
means for packing a target user buffer of the target computing node into the target copy buffer; and
means for initiating an RDMA write from the target copy buffer into the origin user buffer.

39. An apparatus according to claim 25, further including
means for providing origin user data of the origin computing node;
means for causing a long send thread to send the origin user data to the target process thread;
means for causing the target progress thread to receive the origin user data into the target copy buffer; and
means for unpacking the received origin user data into a target user buffer of the target computing node.

40. An apparatus according to claim 25, further including
means for providing origin user data of the origin computing node;
means for causing the long send thread to send data in the origin user buffer to the target progress thread;
means for causing the target progress thread to receive the origin user data into the target copy buffer; and
means for unpacking the received origin user data into a target user buffer of the target computing node.

41. A system for high performance message passing between an origin computing node and a target computing node, comprising:
a module for using an origin process user thread and an origin user buffer of the origin computing node;
a module for using a target process user thread with a target user buffer, and using a target progress thread with a target copy buffer of the target computing node;
a module for causing the target progress thread to receive a message from the origin process user thread to initiate a one sided communication operation; and
a module for causing the target copy buffer to respond to the received message for assisting completing of communication operation.

42. A system according to claim 41, further including a module for using an origin progress user thread and an origin copy buffer of the origin computing node.

43. A system according to claim 41, further including:
a module for providing target data in the target copy buffer; and
a module for causing the target data to be deposited into the origin user buffer via the target progress thread.

44. A system according to claim 41, further including:
a module for providing target data in the target copy buffer; and
a module for causing the target data to be sent to the origin progress thread via the long send thread for deposit in the origin copy buffer.

45. A system according to claim 41, further including a module for communicating the messages via RDMA.

46. A system according to claim 41, further including:
a module for providing origin user data of the origin computing node; and
a module for initiating an RDMA write transfer from the origin user thread to the target user buffer.

47. A system according to claim 41, further including:
a module for providing origin user data of the origin computing node; and
a module for causing the origin long send thread to send the origin user data to the target progress thread.

48. A system according to claim 41, further including
a module for providing origin user data of the origin computing node;
a module for initiating an RDMA read operation from the origin user buffer to the target copy buffer;
a module for performing an accumulation operation of the target copy buffer onto the target user buffer.

49. A system according to claim 41, further including
a module for providing origin user data of the origin computing node;
a module for sending a reply message from the target progress thread to the origin progress thread;
a module for initiating an RDMA write transfer from the origin user buffer to the target copy buffer;
a module for performing an accumulation operation of the target copy buffer onto a target user buffer of the target computing node.

50. A system according to claim 41, further including a module for initiating an RDMA read transfer from a target user buffer of the target computing node.

51. A system according to claim 41, further including
a module for sending a request to the target process thread for initiating an RDMA write operation; and
a module for initiating an RDMA write operation between a target user buffer of the target computing node and the origin user buffer.

52. A system according to claim 41, further including
a module for initiating an RDMA read from the origin user buffer to the target copy buffer; and
a module for unpacking the data from the target copy buffer into a target user buffer of the target computing node.

53. A system according to claim 41, further including
a module for sending a reply from the target progress thread to the origin progress thread;
a module for initiating an RDMA write from the origin user buffer to the target copy buffer;
a module for unpacking the data from the target copy buffer into a target user buffer of the target computing node.

54. A system according to claim 41, further including
a module for packing a target user buffer of the target computing node into the target copy buffer; and
a module for initiating an RDMA write from the target copy buffer into the origin user buffer.

55. A system according to claim 41, further including
a module for providing origin user data of the origin computing node;
a module for causing a long send thread to send the origin user data to the target process thread;
a module for causing the target progress thread to receive the origin user data into the target copy buffer; and
a module for unpacking the received origin user data into a target user buffer of the target computing node.

56. A system according to claim 41, further including
a module for providing origin user data of the origin computing node;
a module for causing the long send thread to send the origin user thread to the target progress thread;
a module for causing the target progress thread to receive the origin user data into the target copy buffer; and
a module for unpacking the received origin user data into a target user buffer of the target computing node.

57. A computer readable medium having stored thereon computer executable instructions for performing a method for high performance message passing between an origin computing node and a target computing node, comprising:
using an origin process user thread and an origin user buffer of the origin computing node;
using a target process user thread with a target user buffer, and using a target progress thread with a target copy buffer of the target computing node;
causing the target progress thread to receive a message from the origin process user thread to initiate a one sided communication operation; and
causing the target copy buffer to respond to the received message for assisting completing of communication operation.

58. A computer readable medium according to claim 57, further including using an origin process user thread and an origin copy buffer the origin computing node.

59. A computer readable medium according to claim 57, further including:
providing target data in the target copy buffer; and
causing the target data to be deposited into the origin user buffer via the target progress thread.

60. A computer readable medium according to claim 57, further including:
providing target data in the target copy buffer; and
causing the target data to be deposited into the origin user buffer via the long send thread.

61. A computer readable medium according to claim 57, further including communicating the messages via RDMA.

62. A computer readable medium according to claim 57, further including:
providing origin user data of the origin computing node; and
initiating an RDMA write transfer from the origin user buffer to the target user buffer.

63. A computer readable medium according to claim 57, further including:
providing origin user data of the origin computing node; and
causing the origin long send thread to send the origin user data to the target progress thread.

64. A computer readable medium according to claim 57, further including
providing origin user data of the origin computing node;
initiating an RDMA read operation from the origin user buffer to the target copy buffer;
performing an accumulation operation of the target copy buffer onto the target user buffer.

65. A computer readable medium according to claim 57, further including
providing origin user data of the origin computing node;
sending a reply message from the target progress thread to the origin progress thread;
initiating an RDMA write transfer from the origin user buffer to the target copy buffer;
performing an accumulation operation of the target copy buffer onto a target user buffer of the target computing node.

66. A computer readable medium according to claim 57, further including initiating an RDMA read transfer from a target user buffer of the target computing node.

67. A computer readable medium according to claim 57, further including
sending a request to the target process thread for initiating an RDMA write operation; and
initiating an RDMA write operation between a target user buffer of the target computing node and the origin user buffer.

68. A computer readable medium according to claim 57, further including
initiating an RDMA read from the origin user buffer to the target copy buffer; and
unpacking the data from the target copy buffer into a target user buffer of the target computing node.

69. A computer readable medium according to claim 57, further including
sending a reply from the target progress thread to the origin progress thread;
initiating an RDMA write from the origin user buffer to the target copy buffer;
unpacking the data from the target copy buffer into a target user buffer of the target computing node.

70. A computer readable medium according to claim 57, further including
packing a target user buffer of the target computing node into the target copy buffer; and
initiating an RDMA write from the target copy buffer into the origin user buffer.

71. A computer readable medium according to claim 57, further including
providing origin user data of the origin computing node;
causing a long send thread to send the origin user data to the target process thread;
causing the target progress thread to receive the origin user data into the target copy buffer; and
unpacking the received origin user data into a target user buffer of the target computing node.

72. A computer readable medium according to claim 57, further including
providing origin user data of the origin computing node;
causing the long send thread to send the origin user thread to the target progress thread;
causing the target progress thread to receive the origin user data into the target copy buffer; and
unpacking the received origin user data into a target user buffer of the target computing node.

73. An apparatus for providing high performance message passing between an origin computing node and a target computing node, comprising:
an origin processor for executing an origin process user thread of the origin computing node;
an origin memory including an origin user buffer of the origin computing node;
a target processor for executing a target process user thread and a target progress thread of the target computing node;
a target memory including a target user buffer and a target copy buffer of the target computing node;
the target processor for executing a target progress thread for receiving a message from the origin process user thread to initiate a one sided communication operation; and
wherein the target copy buffer responds to the received message for assisting completing communication operations.

74. An apparatus according to claim 73, wherein the origin processor executes an origin progress thread and an origin copy buffer of the origin computing node.

75. An apparatus according to claim 73, wherein the target processor provides target data in the target copy buffer and for causing the target data to be deposited into the origin user buffer via the target progress thread.

76. An apparatus according to claim 73 wherein the target processor provides target data in the target copy buffer and for causing the target data to be sent to the origin user thread via the long send thread for deposit in the origin user buffer.

77. An apparatus according to claim 73, wherein the processors communicate the messages via RDMA.

78. An apparatus according to claim 73, wherein the origin processor provides origin user data of the origin computing node and for initiating an RDMA write transfer from the origin user buffer to the target user buffer.

79. An apparatus according to claim 73, wherein the origin processor for providing origin user data of the origin computing node and for causing the origin long send thread to send the origin user data to the target progress thread.

80. An apparatus according to claim 73, wherein the origin processor provides origin user data of the origin computing node and for initiating an RDMA read operation from the origin user buffer to the target copy buffer; and the target processor performs an accumulation operation of the target copy buffer onto the target user buffer.

81. An apparatus according to claim 73, the origin processor provides origin user data of the origin computing node; the target processor sends a reply message from the target progress thread to the origin progress thread; the origin processor initiates an RDMA write transfer from the origin user buffer to the target copy buffer; and
the target processor performs an accumulation operation of the target copy buffer onto a target user buffer of the target computing node.

82. An apparatus according to claim 73, wherein the target processor initiates an RDMA read transfer from a target user buffer of the target computing node.

83. An apparatus according to claim 73, wherein the origin processor sends a request to the target process thread for initiating an RDMA write operation; and wherein the target processor initiates an RDMA write operation between a target user buffer of the target computing node and the origin user buffer.

84. An apparatus according to claim 73 wherein the origin processor initiates an RDMA read from the origin user buffer to the target copy buffer; and wherein the target processor unpacks the data from the target copy buffer into a target user buffer of the target computing node.

85. An apparatus according to claim 73, wherein a target processor sends a reply from the target progress thread to the origin progress thread; wherein an origin processor initiates an RDMA write from the origin user buffer to the target copy buffer; and wherein the target processor unpacks the data from the target copy buffer into a target user buffer of the target computing node.

86. An apparatus according to claim 73, wherein a target processor packs a target user buffer of the target computing node into the target copy buffer and for initiating an RDMA write from the target copy buffer into the origin user buffer.

87. An apparatus according to claim 73, wherein an origin processor provides origin user data of the origin computing node and for causing a long send thread to send the origin user data to the target process thread; wherein a target processor causes the target progress thread to receive the origin user data into the target copy buffer; and wherein the origin processor unpacks the received origin user data into a target user buffer of the target computing node.

88. An apparatus according to claim 73, wherein the origin processor provides origin user data of the origin computing node and for causing the long send thread to send the origin user thread to the target progress buffer; wherein a target processor causes the target progress thread to receive the origin user data into the target copy buffer; and wherein the target processor unpacks the received origin user data into a target user buffer of the target computing node.
